(19) United States
(12) Patent Application Publication
(10) Pub. No.: US 2016/0251565 A1
(43) Pub. Date: Sep. 1, 2016

(54) METHOD FOR PRODUCING HYDROCARBON FLUID FROM HYDROCARBON FLUID-RICH SHALE

(71) Applicant: KANEKA CORPORATION, Osaka-shi, Osaka (JP)

(72) Inventors: Satohiro YANAGISAWA, Tokyo (JP); Masashi IZUMIDA, Takasago-shi (JP)

(73) Assignee: KANEKA CORPORATION, Osaka-shi, Osaka (JP)

(21) Appl. No.: 15/032,440

(22) PCT Filed: Nov. 4, 2014
(86) PCT No.: PCT/JP2014/079224

§ 371 Date: Apr. 27, 2016

(30) Foreign Application Priority Data
Nov. 5, 2013 (JP) 2013-229281

(51) Int. Cl. C09K 8/60; E21B 43/26; C09K 8/68

(52) U.S. Cl. CPC C09K 8/602; C09K 8/68; E21B 43/26

(57) ABSTRACT

The objective of the present invention is to provide a method for efficiently producing a hydrocarbon fluid from a hydrocarbon fluid-rich shale even under high temperature without giving an excessive load to the environment. The method for producing a hydrocarbon fluid from hydrocarbon fluid-rich shale according to the present invention is characterized in comprising the steps of excavating a horizontal wellbore in a layer of the hydrocarbon fluid-rich shale, injecting a pressurized fracturing fluid into the horizontal wellbore to fracture the hydrocarbon fluid-rich shale, taking out the hydrocarbon fluid onto the ground from the fractured hydrocarbon fluid-rich shale, wherein a biosurfactant-containing solution is used as the fracturing fluid.

### TECHNICAL FIELD

The present invention relates to a method for efficiently producing a hydrocarbon fluid from a hydrocarbon fluid-rich shale without giving an excessive load to the environment.

### BACKGROUND ART

When an organic substance derived from an organism deposits and undergoes chemical change due to pressure and heat under the ground over a long period, petroleum and natural gas are produced. The produced petroleum and natural gas move by little and little from a source rock to a reservoir layer, and accumulates under an impervious cap rock such as clay and sandstone to form an oilfield and a gas field. Petroleum and natural gas have been conventionally won by excavating a vertical wellbore into an oilfield and a gas field.

However, petroleum and natural gas also remain in a source rock. In the past, such a remaining petroleum and natural gas could not be technically won, or it made no business sense to win the remaining petroleum and natural gas in terms of cost. However, the remaining petroleum and natural gas have been recently won due to technological innovation. As the remaining petroleum and natural gas which can be won, shale oil and shale gas are exemplified.

Shale is one kind of a mudstone and has the tendency to be peeled off into a flake shape. On the basis of the property, hydraulic fracturing technology has been developed and is generally used at the present time. In hydraulic fracturing technology, a pressurized fracturing fluid is injected into a wellbore to fracture shale and oil or gas is taken out from the generated fracture.

As a fracturing fluid used in hydraulic fracturing technology, crude oil or purified oil was once used but a solution containing water as a solvent is mainly used at present. For example, Patent document 1 discloses a fracturing fluid which is prepared by dispersing a benzoate ester compound in an aqueous solvent and which contains a proppant. In addition, Patent document 2 discloses a fluid containing a natural polymer such as preliminarily gelatinized cornstarch and a synthetic biopolymer such as xanthane gum. The fluid is not used as a fracturing fluid but used for drilling and restoring a soil oil layer which is environmentally polluted.

A surfactant is blended into a fracturing fluid in some cases in order to disperse a lipophilic component or to reduce an interfacial tension between a hydrocarbon and water or between a hydrocarbon and shale. When the interfacial tension is reduced, the fracturing fluid can be introduced in a micropore and a hydrocarbon separation efficiency from shale can be improved. Patent document 3 discloses a cation fluoride surfactant applicable to a gas field and petroleum field.

### PRIOR ART DOCUMENT

### Patent Document

Patent Document 1: JP 2003-533619 T

Patent Document 2: JP 2000-511222 T

Patent Document 3: JP 2013-508278 T

### DISCLOSURE OF THE INVENTION

### Problems to Be Solved By the Invention

As described above, a surfactant is blended into a fracturing fluid for winning a hydrocarbon fluid such as shale gas and shale oil from a hydrocarbon fluid-rich shale in some cases. However, a surfactant may have a negative effect on the environment.

Accordingly, the objective of the present invention is to provide a method for efficiently producing a hydrocarbon fluid from a hydrocarbon fluid-rich shale even under high temperature without giving an excessive load to the environment.

### Means For Solving the Problems

The inventors of the present invention studied earnestly in order to solve the above-described problem. As a result, the inventors completed the present invention by finding that the above-described problem can be solved by using a biosurfactant, which is a surfactant derived from an organism, since the load to the environment is small due to high biodegradability thereof, the formulation concentration thereof can be reduced and the amount to be remained in the environment can be reduced due to high surface activating ability thereof, and the surface activating ability thereof can be sufficiently demonstrated even under high temperature in a hydrocarbon fluid-rich shale layer.

Hereinafter, the present invention is described.

[1] A method for producing a hydrocarbon fluid from hydrocarbon fluid-rich shale,

comprising the steps of
excavating a horizontal wellbore in a layer of the hydrocarbon fluid-rich shale,
injecting a pressurized fracturing fluid into the horizontal wellbore to fracture the hydrocarbon fluid-rich shale,
taking out the hydrocarbon fluid onto the ground from the fractured hydrocarbon fluid-rich shale,

wherein a biosurfactant-containing solution is used as the fracturing fluid.

[2] The method according to the above [1], wherein the biosurfactant is a lipopeptide compound or a salt thereof.

[3] The method according to the above [1], wherein the biosurfactant is surfactin represented by the following formula (I) or a salt thereof:

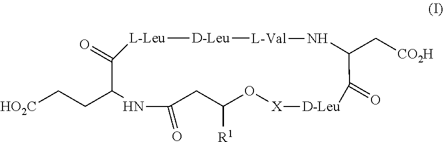

wherein ‘X’ is a residue of an amino acid selected from leucine, isoleucine and valine, and ‘R¹’ is a C₉₋₁₈ alkyl group.

[4] The method according to anyone of the above [1] to [3], wherein a concentration of the biosurfactant in the fracturing fluid is not less than 0.000005 mass % and not more than 0.005 mass %.

Since a biosurfactant may exert surface active function even in a lower concentration in comparison with a general surfactant, when the above-described concentration is 0.000005 mass % or more, the production efficiency of a hydrocarbon fluid from hydrocarbon fluid-rich shale can be sufficiently improved. On the one hand, when the above-described concentration is excessively high, the effect becomes saturated and high cost becomes necessary. The above-described concentration is therefore preferably 0.005 mass % or less.

[5] The method according to the above [3], wherein the biosurfactant is a sodium salt of the surfactin (I).

The water solubility of a sodium salt of the surfactin (I) is high and the salt is hardly precipitated even under high temperature. In addition, the effect of the salt was confirmed by the present inventors' experimental knowledge.

[6] Use of a biosurfactant as a surfactant component in a fracturing fluid used for winning a hydrocarbon fluid from a hydrocarbon fluid-rich shale.

[7] The use according to the above [6], wherein the biosurfactant is a lipopeptide compound or a salt thereof.

[8] The use according to the above [6], wherein the biosurfactant is surfactin represented by the following formula (I) or a salt thereof:

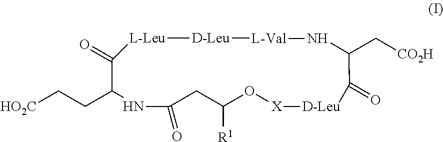

wherein ‘X’ is a residue of an amino acid selected from leucine, isoleucine and valine, and ‘R¹’ is a C₉₋₁₈ alkyl group.

[9] The use according to any one of the above [6] to [8], wherein a concentration of the biosurfactant in the fracturing fluid is not less than 0.000005 mass % and not more than 0.005 mass %.

[10] The use according to the above [8], wherein the biosurfactant is a sodium salt of the surfactin (I).

### Effect of the Invention

The biosurfactant used in the present invention as a surfactant is safe with a small environmental load. Accordingly, if the biosurfactant is blended into a fracturing fluid to be used in a large amount, a bad influence on the environment is very small. In addition, the biosurfactant used in the present invention can exhibit surface active function even under high temperature in a hydrocarbon fluid-rich shale layer. As a result, it becomes possible that the fracturing fluid according to the present invention is introduced into a narrow space and a hydrocarbon fluid is readily taken out from hydrocarbon fluid-rich shale. The present invention is therefore very excellent as a technology to efficiently produce a hydrocarbon fluid from hydrocarbon fluid-rich shale, which has been recently attracted attention as a valuable energy resource.

### BRIEF DESCRIPTION OF THE DRAWING

FIG. 1 is a graph to demonstrate a relation between temperature and a surface tension of a sodium surfactin aqueous solution or a sodium dodecyl sulfate aqueous solution.

### MODE FOR CARRYING OUT THE INVENTION

Hereinafter, the present invention method is described with the order of implementation.

(1) Step of Excavating Horizontal Wellbore

In the present invention method, first, a horizontal wellbore is excavated in a hydrocarbon fluid-rich shale layer which contains a hydrocarbon fluid.

A hydrocarbon fluid to be won by the present invention method is a hydrocarbon gas and a hydrocarbon oil which can be utilized as energy, specifically is so-called shale gas and shale oil. Shale gas contains methane as a main component and other hydrocarbon gas. Shale oil contains much the same components as a crude oil. In the present invention, a hydrocarbon gas and a hydrocarbon oil which may be utilized as energy are won with no particular restriction, and may contain a component other than the above-described components.

In the present invention, a hydrocarbon fluid is won from hydrocarbon fluid-rich shale. Hydrocarbon fluid-rich shale means shale which contains the above-described hydrocarbon fluid relatively in profusion. A hydrocarbon fluid can be obtained from a fracture made by a pressurized fracturing fluid in hydrocarbon fluid-rich shale, since hydrocarbon fluid-rich shale is readily broken in a thin layer state along a depositional surface. In general, hydrocarbon fluid-rich shale contains not less than about 0.5% and not more than about 25% of an organic compound.

A horizontal wellbore is different from a diagonal wellbore and a vertical wellbore, which is vertically excavated from directly above a petroleum field and a gas field, and means a wellbore which is generally excavated along a reservoir of petroleum and natural gas, specifically along a hydrocarbon fluid-rich shale layer in the case of shale oil and shale gas. A horizontal wellbore is not necessarily strictly-defined, but may be defined as a wellbore which is excavated at an inclination angle of not less than 85° in a hydrocarbon fluid-rich shale layer. In the cases of a vertical wellbore and a diagonal wellbore, a hydrocarbon fluid radially flows in a circular state toward a wellbore; on the one hand, a hydrocarbon fluid flows in a horizontal direction in the case of a horizontal wellbore.

A horizontal wellbore is mainly classified into a long radius type, a medium radius type and a short radius type depending on a curvature radius in an angle increasing zone from a kickoff point to an end of curve. The kickoff point means a position at which a wellbore direction starts to firstly bend from a vertical direction. The end of curve means a position at which an inclination angle becomes 90°. The curvature radius and angle increasing rate of a long radius type is respectively 3000 to 1000 ft and 3 to 6°/100 ft, the curvature radius and angle increasing rate of a medium radius type is respectively 700 to 300 ft and 8 to 20°/100 ft, and the curvature radius and angle increasing rate of a short radius type is respectively 40 to 20 ft and 1.5 to 3°/100 ft. The present invention can be applied to any type of horizontal wellbore. The horizontal wellbore according to the present invention may be a multi lateral wellbore and an extended reach wellbore. A multi lateral wellbore is prepared by excavating two or more wellbores as branches in horizontal directions from one wellbore. In an extended reach wellbore, an inclination having an angle of more than 70° continues for 800 to 3000 m on average.

The horizontal wellbore may be excavated according to an ordinary method. For example, the horizontal wellbore is first excavated in a vertical direction by the own weight of a drill string, and then excavated in an oblique direction at desired angle and in a horizontal direction using a directional digging system containing the combination of a mud motor and a vent sub, a steerable motor, a rotary steerable system and the like.

(2) Step of Fracturing Hydrocarbon Fluid-Rich Shale

Then, a pressurized fracturing fluid is injected into the horizontal wellbore to make a fracture in hydrocarbon fluid-rich shale. By such a treatment, it becomes possible to take out a hydrocarbon fluid which remains in hydrocarbon fluid-rich shale.

In the present invention, a solution containing a biosurfactant is used as a fracturing fluid.

A fracturing fluid is generally used in a large amount of 3000 to 10000 m³ per one wellbore. However, only a part of a fracturing fluid is recovered. As a result, a compound of which biodegradability is low remains in the environment. It is apprehended that a fracturing fluid gives an adverse effect to the environment, since a fracturing fluid contains a cation fluoride surfactant described in Patent document 3 or a general surfactant such as sodium dodecyl sulfate and a sodium alkylbenzene sulfonate which do not contain fluorine. In fact, particularly when development area of shale gas is near an aquifer under the ground or a house, a risk of environmental pollution is pointed out. On the one hand, a non-ionic surfactant, which is an ester compound of a higher fatty acid and a polyol such as sucrose, is considered to have high safety and low environmental load, as a non-ionic surfactant is widely used for a food, a cosmetic or the like. However, a non-ionic surfactant has disadvantage that a non-ionic surfactant is precipitated at high temperature and as a result, cannot exert the function and effect. The temperature of a hydrocarbon fluid-rich shale layer is considerably high due to geothermal heat, since a hydrocarbon fluid-rich shale layer exists several hundred to several thousand meters underground and for example, the temperature more than 3000 meters underground is generally more than 100° C. It is therefore impossible to blend a non-ionic surfactant into a fracturing fluid.

On the one hand, a biosurfactant has low environmental load and is safe, and even a small amount of a biosurfactant can exert the effect due to a high surface activating ability. In addition, a biosurfactant can exert the function and effect even under high temperature, such as in a hydrocarbon fluid-rich shale layer, since a biosurfactant is excellent in heat resistance. As a result, the fracturing fluid according to the present invention can be sent into the ground at low energy, and introduced even into a narrow space. In addition, by using the fracturing fluid, fracture can be made and maintained, and a hydrocarbon fluid can be readily separated from hydrocarbon fluid-rich shale. Furthermore, the dispersibility of a lipophilic component and a water-insoluble component in the fracturing fluid can be improved.

A certain microorganism lives in very severe environment and has survived a struggle for survival by producing a biosurfactant to relieve a severe environment around the cell. For example, a microorganism which lives in lipophilic environment such as a petroleum field and which produces a biosurfactant is known. A biosurfactant produced by such a microorganism has high affinity for a hydrocarbon such as oil. When such a biosurfactant is blended into a fracturing fluid, a unique effect may be obtained. For example, a hydrocarbon which cannot be emulsified by a general surfactant may be emulsified; as a result, the production efficiency of a hydrocarbon may be remarkably increased. The above-described effects are considered to be based on the extremely special and precisive chemical structure which is built by only an enzyme reaction of an organism. The biosurfactant produced by a microorganism which lives in lipophilic environment is exemplified by mannosylerythritol lipid, sophorolipid, trehalose lipid, rhamnolipid, spiculisporic acid, emulsan, surfactin and arthrofactin.

A biosurfactant which is blended into a fracturing fluid is immediately degraded after use, since a biosurfactant has high environmental adaptability. In addition, an amino acid, a fatty acid, a sugar and the like generated by the degradation of a biosurfactant nourish various microorganisms; as a result, various microorganisms are activated and various organic compounds contained in a fracturing fluid may be degraded more promptly.

A biosurfactant is a natural surfactant which is produced by a microorganism, and has a very high safety to the environment and human body since a biosurfactant exhibits a high biodegradability and low skin irritation. Such a biosurfactant is exemplified by a glycolipid biosurfactant such as mannosylerythritol lipid, sophorolipid, trehalose lipid and rhamnolipid; a fatty acid biosurfactant such as spiculisporic acid; a polymer biosurfactant such as emulsan; a lipopeptide compound biosurfactant. The biosurfactant is not restricted to the above examples.

In particular, the biosurfactant used in the present invention is preferably a lipopeptide compound biosurfactant. A lipopeptide compound biosurfactant is exemplified by surfactin, arthrofactin, and a salt thereof. More specifically, the biosurfactant is exemplified by a surfactant produced by a bacterium of the genus Bacillus, such as Bacillus subtilis, and preferably exemplified by surfactin and a salt thereof.

In the present invention, surfactin is represented by the following formula (1):

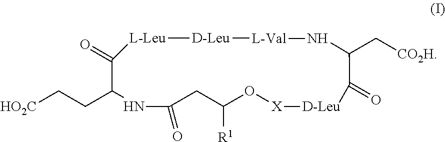

Hereinafter, the above surfactin is referred to as “surfactin (I)”.

In the formula (I), the bases of the carboxymethyl group and the carboxyethyl group are optically-active centers.

The ‘X’ is a residue of an amino acid selected from leucine, isoleucine and valine. Although the amino acid residue as ‘X’ may be either in a L-form or a D-form, the L-form is preferred.

The ‘R¹’ is a C₉₋₁₈ alkyl group. The term “C₉₋₁₈ alkyl group” means a linear or branched monovalent saturated hydrocarbon group having not less than 9 and not more than 18 carbon atoms. The example thereof includes n-nonyl, 6-methyloctyl, 7-methyloctyl, n-decyl, 8-methylnonyl, n-undecyl, 9-methyldecyl, n-dodecyl, 10-methylundecyl, n-tridecyl, 11-methyldodecyl, n-tetradecyl, n-pentadecyl, n-hexadecyl, n-heptadecyl and n-octadecyl.

One kind of the above surfactin (I) or not less than two kinds of the above surfactins (I) may be used. For example, two or more surfactins (I) which have different C₉₋₁₈ alkyl groups as R¹ may be used.

The surfactin (I) can be isolated from a culture medium prepared by culturing a microorganism such as a strain belonging to Bacillus subtilis in accordance with a known method. The surfactin (I) may be a purified product or an unpurified product. For example, a culture medium as it is may be used. The surfactin (I) obtained by a chemical synthesis method may be similarly used.

A salt of the surfactin (I) maybe also used. The counter cation which constitutes such a salt is not particularly restricted and is exemplified by an alkali metal ion and an ammonium ion.

An alkali metal ion used for a salt of the surfactin (I) is not particularly restricted, and exemplified by a lithium ion, a sodium ion and a potassium ion. The two alkali metal ions are the same as or different from each other.

A substituent of an ammonium ion is exemplified by an organic group. Such an organic group is exemplified by an alkyl group such as methyl, ethyl, n-propyl, isopropyl, n-butyl and t-butyl; an aralkyl group such as benzyl, methylbenzyl and phenylethyl; and an aryl group such as phenyl, toluyl and xylyl. An ammonium ion is exemplified by tetramethylammonium ion, tetraethylammonium ion and pyridinium ion.

Two counter cations in a salt of the surfactin (I) may be the same as or different from each other. In addition, one of the carboxy groups may be in the state of —COOH or —COO⁻.

A concentration of the biosurfactant in the fracturing fluid may be appropriately adjusted, and is preferably not less than 0.000005 mass % and not more than 0.005 mass %. When the above-described concentration is 0.000005 mass % or more, the production efficiency of a hydrocarbon fluid from hydrocarbon fluid-rich shale can be sufficiently improved, since a biosurfactant may exert surface active function even in a lower concentration in comparison with a general surfactant. On the one hand, when the above-described concentration is excessively high, the effect becomes saturated and high cost becomes necessary. The above-described concentration is therefore preferably 0.005 mass % or less. The above-described concentration is more preferably not less than 0.00001 mass %, more preferably not less than 0.00005 mass %, and more preferably not more than 0.001 mass %.

The fracturing fluid used in the present invention method may contain a proppant and other additive agent in addition to water and a biosurfactant.

As a solvent of the fracturing fluid, crude oil, product oil, kerosene and the like may be used other than water. In terms of environmental load, it is preferred to use water. As water, seawater may be used in addition to well water, groundwater, lake water and the like.

A ratio of the solvent in the fracturing fluid may be appropriately adjusted and for example, maybe adjusted to not less than about 50 mass % and not more than about 95 mass %.

A proppant is particularly important for a fracturing fluid. Specifically, even when a fracture is made in hydrocarbon fluid-rich shale by a pressurized fluid, the fracture is immediately closed, since a hydrocarbon fluid-rich shale exists deep in the ground and is in a high pressure condition. Accordingly, a hard fine particle which is referred to as proppant is blended into a fracturing fluid and made to remain in the caused fracture in order to prevent the fracture from being completely closed and to efficiently take out a hydrocarbon fluid.

A proppant may be selected in terms of the purpose or cost, and a ceramic particle, a sand particle coated with a resin, an uncoated sand particle or the like is used as a proppant. For example, a particle size of a ceramic particle can be adjusted. In addition, a ceramic particle has high strength and is excellent in heat resistance; however, a ceramic particle is relatively expensive. On the one hand, with respect to a sand particle, it is relatively difficult to adjust a particle size, and the strength is relatively low. A sand particle coated with a resin shows an intermediate properties between the properties of a ceramic particle and a sand particle. A proppant may be selected in consideration of the above-described properties.

A mixing ratio of the proppant is not particularly restricted. For example, a proppant may not be blended at the outset of hydraulic fracturing treatment and the mixing ratio thereof maybe increased gradually or continuously. For example, a concentration of the proppant in the fracturing fluid containing a proppant may be adjusted to not less than about 1 mass % and not more than about 30 mass %.

Into the fracturing fluid, other additive agent may be added. Such an additive agent is exemplified by a thickening gelling agent such as polyethyleneglycol, xanthane gum and guar gum; a chelating agent such as ethylenediaminetetraacetate (EDTA), 1,4,7,10-tetraazacyclododecane-1,4,7,10-tetraacetate (DOTA), ethylenediamine-N,N′-disuccinate (EDDS), iminodiacetate, and salts thereof; a pH adjuster such as citric acid, gluconic acid, succinic acid, potassium carbonate, sodium hydrogencarbonate, carbon dioxide and lactic acid; a salt such as sodium chloride, potassium chloride and calcium chloride; an acidic component such as hydrochloric acid and sulfuric acid; a polymer to reduce friction.

A composition of the fracturing fluid may be changed as needed. For example, a fracture is made in hydrocarbon fluid-rich shale initially without using a proppant, and after the length and width of the fracture are enlarged, the fracture may be maintained with gradually increasing the concentration of a proppant.

A pressure of the fracturing fluid may be appropriately adjusted. For example, a pressure of the fracturing fluid may be adjusted with measuring a seismic wave due to hydraulic fracturing of hydrocarbon fluid-rich shale by a micro-seismic technology. Recently, it has been not needed to increase the viscosity of a fracturing fluid due to improvement in the ability of a pump.

(3) Step of Obtaining Hydrocarbon Fluid

A hydrocarbon fluid which remains in hydrocarbon fluid-rich shale can be taken out to the ground through the fracture which is made in the above-described fracturing step and a through wellbore.

(4) Step of Post-Processing

A part of the fracturing fluid used in the above-described fracturing step is recovered to the ground. It is preferred that the recovered fracturing fluid is purified to a certain degree to be recycled.

The present application claims the benefit of the priority date of Japanese patent application No. 2013-229281 filed on Nov. 5, 2013. All of the contents of the Japanese patent application No. 2013-229281 filed on Nov. 5, 2013, are incorporated by reference herein.

### EXAMPLES

Hereinafter, the present invention is described in more detail with Examples. However, the present invention is not restricted to the following Examples in any way, and it is possible to carry out the present invention according to the Examples with an additional appropriate change within the range of the above descriptions and the following descriptions. Such a changed embodiment is also included in the technical scope of the present invention.

### Example 1

### Test for Surface Active Function Under High Temperature

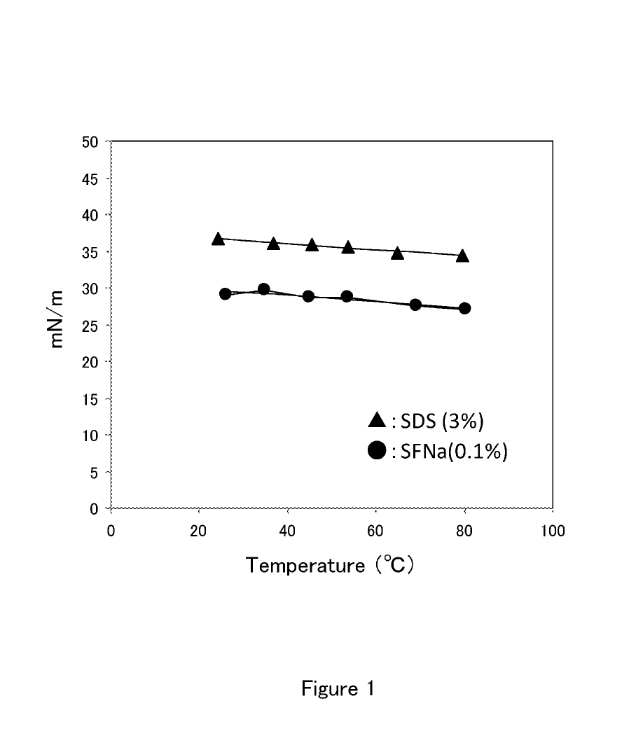

A specified amount of sodium surfactin (SFNa) was dissolved in water, and the mixture was stirred using a Vortex mixer for 3 minutes to prepare 0.1 mass % aqueous solution. A circulation type thermostatic bath (“FR-004” manufactured by TGK Co., Ltd.) was connected to a jacket type stage of a high performance surface tension meter (“DY-500” manufactured by Kyowa Interface Science Co., LTD.). Surface tensions of the aqueous solution at each temperature were measured using the high performance surface tension meter. The temperature was measured using a surface thermometer attached to the surface tension meter. In addition, the surface tensions of 3 mass % aqueous solution of sodium dodecyl sulfate (SDS) were similarly measured for comparison. The result is shown in FIG. 1.

The surface tensions of water are 72 mN/m at 25° C. and 63 mN/m at 80° C. When sodium dodecyl sulfate (SDS) was added, the surface tension of water could be decreased to about 35 mN/m as the result shown in FIG. 1. Furthermore, an excellent surface active function of sodium surfactin (SFNa), which is a biosurfactant, was demonstrated as even when sodium surfactin (SFNa) was added in thirtieth amount of sodium dodecyl sulfate, the surface tension of water was decreased to about 25 mN/m even under high temperature of 80° C. as the result shown in FIG. 1. It was confirmed by the results that when sodium surfactin is blended into a fracturing fluid, a fracture can be made in hydrocarbon fluid-rich shale and a hydrocarbon fluid can be obtained more readily, since sodium surfactin exhibits surface active function even in a hydrocarbon fluid-rich shale layer under high temperature due to geothermal heat and reduces the surface tensions between water and hydrocarbon, between hydrocarbon and hydrocarbon fluid-rich shale, and between water and hydrocarbon fluid-rich shale.

### Example 2

### Relationship Between Concentration and Surface Active Function

An aqueous solution which contained 0.7 mass % of CaCl₂, 0.3 mass % of NaCl and 2.0 mass % of KCl was prepared. Further, sodium surfactin was dissolved in the solution. The solution was heated to 60° C., and the surface tension of the solution was measured similarly to the above-described Example 1 to determine the concentration by which the surface tension of the solution could be reduced to 30 mN/m. In addition, similar experiments were carried out with respect to C12 sodium alkylbenzene sulfonate, which is added to a fracturing fluid as a surfactant, and sodium dodecyl sulfate, which is a general surfactant, for comparison. The results are shown in Table 1. In Table 1, sodium surfactin is abbreviated to “SF”, sodium alkylbenzene sulfonate is abbreviated to “LAS”, and sodium dodecyl sulfate is abbreviated to “SDS”.

TABLE 1

| | 0.00005% | 0.00025% | 0.0005% | 0.03% | 0.06% | 0.1% | 0.3% | 0.5% | 1% |
|---|---|---|---|---|---|---|---|---|---|
| SF | 32.5 | 30.3 | 28.8 | | | | | | |
| LAS | | | | 44.3 | 33.6 | | 28.0 | | |
| SDS | | | | | | 51.2 | | 35.7 | 30.0 |

As the results shown in Table 1, sodium surfactin exhibits surface active function even in a few hundredth use amount of other anionic surfactants. It was therefore demonstrated that when sodium surfactin is blended into a fracturing fluid as a surfactant, the influence given to the environment is very small, since sodium surfactin is a peptide compound and exhibits an excellent surface active function even in a small use amount.

### Example 3

### Winning of Shale Gas

A fracturing fluid containing 90.6 mass % of water, 8.95 mass % of a proppant, 0.11 mass % of an acidic component, 0.08 mass % of a friction reducing agent, 0.05 mass % of potassium chloride, 0.05 mass % of a gelling agent, 0.04 mass % of a scale inhibitor, 0.00025 mass % of sodium surfactin as a surfactant and 0.12 mass % of other component such as an antimicrobial agent is injected into the ground under pressure at a winning field of shale gas. The length and width of fractures in a hydrocarbon fluid-rich shale can be enlarged by continuing the injection under pressure. When a force feeding pump is stopped, the fractures are not closed and the passage of gas is maintained, since the fractures are maintained by the proppant contained in the fracturing fluid. It is expected that when sodium surfactin is used as a surfactant, the production efficiency of gas is improved by enlarging the length of a fracture in comparison with the case where 0.08 mass % of alkylbenzene sulfonate, which has been conventionally used, is used.

1. A method for producing a hydrocarbon fluid from hydrocarbon fluid-rich shale,
comprising the steps of
excavating a horizontal wellbore in a layer of the hydrocarbon fluid-rich shale,
injecting a pressurized fracturing fluid into the horizontal wellbore to fracture the hydrocarbon fluid-rich shale,
taking out the hydrocarbon fluid onto the ground from the fractured hydrocarbon fluid-rich shale,
wherein a biosurfactant-containing solution is used as the fracturing fluid.

2. The method according to claim 1, wherein the biosurfactant is a lipopeptide compound or a salt thereof.

3. The method according to claim 1, wherein the biosurfactant is surfactin represented by the following formula (I) or a salt thereof: 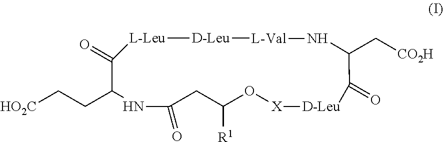
wherein ‘X’ is a residue of an amino acid selected from leucine, isoleucine and valine and ‘R¹’ is a C₉₋₁₈ alkyl group.

4. The method according to claim 1, wherein a concentration of the biosurfactant in the fracturing fluid is not less than 0.000005 mass % and not more than 0.005 mass %.

5. The method according to claim 3, wherein the biosurfactant is a sodium salt of the surfactin (I).

6-0. (canceled)
